(19) United States
(12) Patent Application Publication
(10) Pub. No.: US 2004/0225491 A1
(43) Pub. Date: Nov. 11, 2004

(54) Generic script template engine repository adapter system and method of use

(75) Inventor: Chih-Je Chang, Baihe Jen (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/431,860

(22) Filed: May 8, 2003

(51) Int. Cl. G06F 17/28

(52) U.S. Cl. 704/2

(57) ABSTRACT

The present invention provides a generic script template engine repository adapter system having: a first computer system; a second computer system in operative communication with the first computer system; a script template repository having at least one generic script template; and a generic script translation engine adapter, wherein the at least one generic script template cooperates with the generic script translation engine adapter to translate scripts between the first computer system and the second computer system.

Additionally a method of using the adapter system is provided, wherein the method has the steps of: defining at least one generic script template associated with each of an origination script and a destination script; and using the at least one generic script template and the generic script template engine to uniformly format and translate the origination script and the destination script using an associated plurality of syntax rules.

### FIELD OF THE INVENTION

The present invention relates to a generic script template engine repository adapter system and method and method of use for providing fast script translations between two computer systems.

### BACKGROUND

Many information technology (IT) systems are disposed within different platforms to save time, costs, provide integration and enhance performance. However, IT systems disposed within different platforms must be integrated/re-integrated with other platforms in accordance with a system user's needs.

A system adapter transforms command strings of a first system (system A) to corresponding command strings of a second system (system B) via a system interface operation.

A system adapter is commonly used to exchange messages between two or more systems, which establishes conduit among the various so-called “system interfaces” act as the gate of the system.

A system interface provides a communication conduit between a system (such as PROMIS) and an outside user. The system interface is often provided in the form of a set of application programming interfaces (APIs) or well-defined command strings.

Typically, there are two kinds of script translators used as a system adaptor: a general-purpose adapter and a command specific adapter.

The general-purpose adapter performs all command string transformation with a single processing engine. Typically, the single processing engine is complex, fat, slow, and hard to maintain. The general purpose adapter uses a variety of language characters and provides strict grammar definitions. The general-purpose adapter's complexity makes adoption of a new command string format difficult. The general-purpose adaptor is hard to design and maintain and additionally, performs badly making a general purpose adapter not feasible for use in a real-time application.

The command specific adaptor typically contains a plurality of small translators each capable of handling a command string type, wherein each command string type is associated with a command string. Before the command specific adapter can process a new type of command string, a new translator must be provided. Typically, a large quantity of translators are provided. If a bug is found, each associated translator must be fixed, thus, resulting in a cumbersome process. The command-specific adapter provides a “thin” process unit allowing for fast processing type, can easily copy, modify and run a command string, and is easy to design. However, the command-specific adapter must provide a specified translation for each associated kind of script making the command-specific adapter hard to maintain.

It is desirable to provide a generic script template engine repository adapter system and method.

### SUMMARY OF THE INVENTION

The present invention provides a generic script template engine repository adapter system and method.

The present invention provide a generic script template repository method for a PROMIS system adapter architecture that is used for fast script conversion providing a context-independent script translation engine and one or a plurality of script template repositories.

The present invention provides a structural script template framework that unifies formatting commands. The present invention further provides a plurality of script directives, the plurality of script directives is used to describe complex, repeatable and nested data structures.

The present invention provides interface extensibility, fast translation, and system-scale extensibility. The interface extensibility extends the capability of handling a new interface and significantly reduces maintenance efforts. Additionally, when adding a new type of command string, only the script template repository needs modification, not the script translation engine. The script translation engine is associated with only pre-defined script templates, thereby providing simple and fast translation suitable for real-time application. The command string can be translated to another system by defining a new set of script template repositories because the translation is context-independent.

More particularly, the present invention provides a generic script template engine repository adapter system having:

a first computer system;

a second computer system in operative communication with the first computer system;

a script template repository having at least one generic script template for formatting scripts transferred between the first computer system and the second computer system; and

a generic script translation engine adapter,

wherein the at least one generic script template cooperates with the generic script translation engine adapter to achieve fast script translation between the first computer system and the second computer system.

and the second computer system.

Preferably, first computer system is a process manufacturing integration system (PROMIS) having at least one transfer protocol server for generating at least one or a plurality of PROMIS scripts.

Also preferably, the second computer system is a computer integrated manufacturing (CIM) system has a client application program having at least one client template server for generating a plurality of CIM client application program scripts.

Also, preferably both the PROMIS system and the CIM system may be selected from at least one of an origination system, and a destination system, wherein the origination system has an origination script for sending an initial data request to the destination system, and wherein the destination system has a destination script for sending requested input data to the origination system.

The at least one script template operates to uniformly format at least one script selected from at least an origination script and a destination script using a fixed format terminology, the fixed format terminology having a plurality of syntax items each arranged in accordance with an associated plurality of syntax rules used to define the at least one script template. The associated plurality of syntax rules are preferably selected from a group of a script directive, an operator, and a parameter.

In accordance with a preferred embodiment of the present invention, a first method of using a generic script template engine repository adapter system is also provided. The first method has the steps of:

a) providing an origination system having at least origination script;

b) providing a destination system having at least one destination script;

providing a script template repository for storing at least one generic script template;

c) defining at least one generic script template associated with each of the at least one origination script and the at least one destination script, wherein the at least one generic script template is disposed within the script template repository;

d) providing a generic script template engine; and

e) using the at least one generic script template in cooperation with the generic script template engine to uniformly format and translate at least one script selected from at least the origination script and the destination script using a fixed format terminology, the fixed format terminology having a plurality of syntax items each arranged in accordance with an associated plurality of syntax rules used to define the at least one script template.

Additionally the first method further has the steps of:

a) initiating an input data request using the origination script sent from the origination system;

b) sending input data from the destination system to the generic script template engine upon receiving the input data request from the origination system;

c) translating the input data sent from the destination system using the generic script template engine;

d) sending the translated input data sent from the generic script template engine to the origination system;

e) inputting the translated input data sent from the generic script template engine to a memory location disposed within the origination system via an input expression defined within the at least one generic script template associated with each of the at least one origination script and with the at least one destination script;

f) sending output data output from the origination system to the generic script template engine upon completing step f);

g) translating the output data sent from the destination system using the generic script template engine;

h) sending the translated output data sent from the generic script template engine to the destination system; and

i) inputting the translated output data sent from the generic script template engine to a memory location disposed within the destination system via an output expression defined within the at least one generic script template associated with each of the at least one origination script and with the at least one destination script.

A second method of using a script translation adapter system is provided herewithin. The second method having the steps of:

a) providing an engine adapter system having an origination computer system, a destination computer system, a script template repository, at least one generic script template disposed within the script template repository, and a generic script translation engine adapter;

b) predefining at least one origination command string disposed within the origination computer system into an origination script;

c) predefining at least one destination command string disposed within the destination computer system into a destination script;

d) defining a generic script template associated with each of the at least one origination script and the at least one destination script;

e) adding the defined generic script template to the script template repository; and

f) using the at least one generic script template in cooperation with the generic script template engine to uniformly format and translate at least one script selected from at least the origination script and the destination script using a fixed format terminology, the fixed format terminology having a plurality of syntax items each arranged in accordance with an associated plurality of syntax rules used to define the at least one script template.

### BRIEF DESCRIPTION OF THE DRAWINGS

These and other objects, features and advantages of the present invention will become apparent from the following detailed description and the appended drawings in which:

FIG. 1 is a block diagram overview of a generic script template engine repository adapter system.

FIG. 2 is a syntax diagram of a template structure having an input expression and an output expression in accordance with the present invention.

FIG. 3 is a syntax diagram of an input expression input statement and an input structure a graphical illustration of a material usage subdisplay in accordance with the present invention.

FIG. 4 is a syntax diagram of an input statement and an input structure in accordance with the present invention.

FIG. 5 is a syntax diagram of an input structure in accordance with the present invention.

FIG. 6 is a syntax diagram of an output expression in accordance with the present invention.

FIG. 7 is a syntax diagram of an output statement in accordance with the present invention.

FIG. 8 is a syntax diagram of an output repeat structure in accordance with the present invention.

FIG. 9 is a syntax diagram of an output nested structure in accordance with the present invention.

FIG. 10 is a detailed illustration of a predefined generic script template in accordance with the present invention.

FIG. 11 is a flowchart showing a method of using a generic script template engine repository adapter system in accordance with one embodiment of the present invention.

FIG. 12 is a flowchart showing additional steps of the method as shown in FIG. 11.

FIG. 13 is a flowchart showing a method of using a script translation adapter system in accordance with one embodiment of the present invention.

### DETAILED DESCRIPTION OF THE PREFERRED EMBODIMENTS

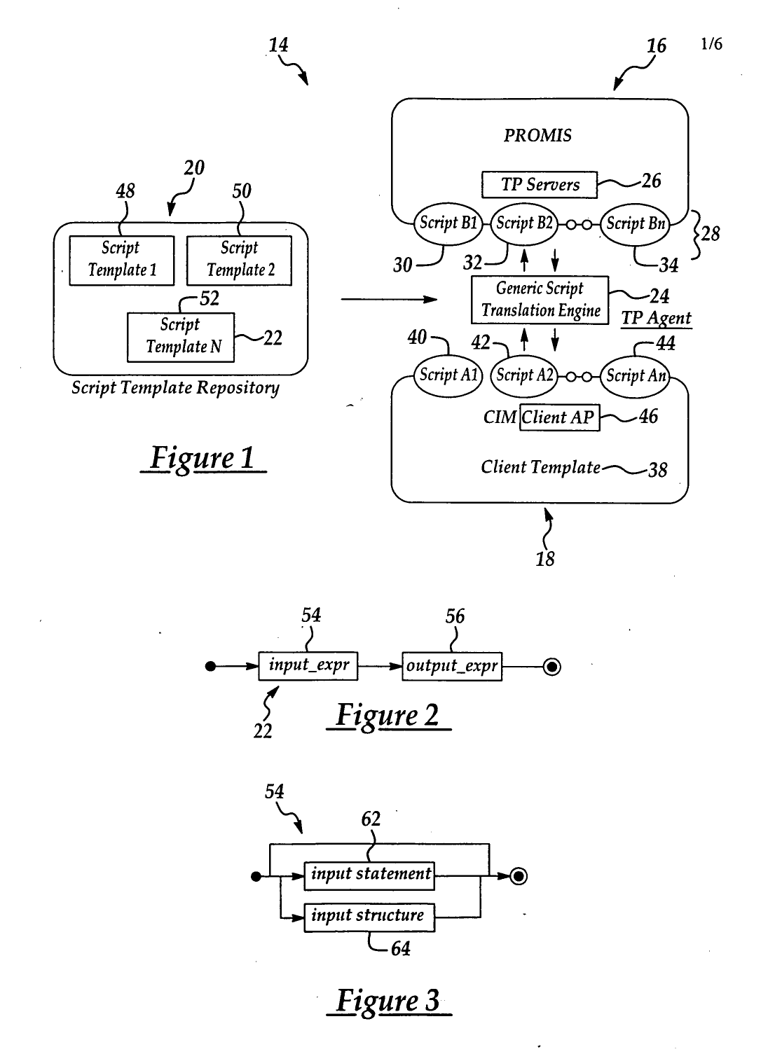

Referring now to the drawings, in particular, FIG. 1 shows a preferred embodiment of the present invention. As shown in FIG. 1, the present invention provides a generic script template engine repository adapter system 14. The generic script template engine repository adapter system having:

a first computer system 16;

a second computer system 18 in operative communication with the first computer system;

a script template repository 20 having at least one generic script template 22 for formatting scripts transferred between the first computer system 16 and the second computer system 18; and

a generic script translation engine adapter 24,

wherein the at least one generic script template 22 cooperates with the generic script translation engine adapter 24 to achieve fast script translation between the first computer system 16 and the second computer system 18.

Preferably, the first computer system 16 is a manufacturing executive system (MES) for controlling and managing operations within a manufacturing facility. Also, preferably, the MES is a process manufacturing integration system (PROMIS) available from the PROMIS System Corporation, wherein the PROMIS system “is a technically advanced, factory automation and management system including a shop floor control system” that “monitors, and controls activity in complex process manufacturing environments” as disclosed in U.S. Pat. No. 5,778,386 LIN. The PROMIS is often used in a complex and precise manufacturing environment such as a wafer fabrication facility. However, the MES system is not limited to the PROMIS but can be any MES system capable of using structured syntax rules as defined further below. However, as shown in a preferred embodiment (shown in FIG. 1) of the present invention, a PROMIS MES is shown for illustrative purposes.

Preferably, the second computer 18 is a computer integrated manufacturing (CIM) system having a client application program in communication with the first system.

Preferably, the PROMIS 16 has at least one transfer protocol (TP) server 26 for generating at least one or a plurality of PROMIS scripts 28, wherein a script is one or a plurality of commands that can be executed without a user interaction. As shown, in FIG. 1 the plurality of scripts are defined as script B1 30, script B2 32, increase to script Bn 34, wherein, wherein n is an integer greater than or equal to zero. Optionally, the PROMIS 16 may have a plurality of TP servers 26 for generating a plurality of PROMIS scripts (B1-Bn).

Preferably, the CIM system 18 has a client application program 36 having at least one client template server 38 for generating a plurality of CIM client application program scripts, wherein the plurality of scripts are defined as script A1 40, script A2 42, increasing to script An 44. Optionally, the CIM system 18 may have a plurality of client application program servers 46 for generating a plurality of client application program scripts (A1-An).

Preferably, each of the respective PROMIS and CIM client application program scripts 30-34, 40-44 may be generated using a script language, wherein the script language is a simple programming language used to create one or a plurality of scripts.

The PROMIS 16 and the CIM client application program 36 may be selected from at least one of an origination system, and a destination system, wherein the origination system has an origination script 30, and wherein the destination system has a destination script 40.

The script template repository 20 uses a script language structure to define handshaking of information between the two systems 16,18. The script template repository 20 has at least one script template 22, and preferably has a plurality of script templates. As shown in FIG. 1, a script template 1 48 is associated with PROMIS script B1 30, and is further associated with the CIM script A1 40; a script template 2 50 is associated with PROMIS script B2 32, and is further associated with the CIM script A2 42. Accordingly, a script template n 52 is associated with PROMIS script Bn 34, and is further associated with the CIM script An 44, wherein the script template repository may have up to n number of script templates (script template n 52) each associated with a PROMIS script and further associated with a CIM script.

The at least one script template 22 operates to uniformly format at least one script selected from at least the origination script and the destination script using a fixed format terminology, the fixed format terminology having a plurality of syntax items each arranged in accordance with an associated plurality of syntax rules used to define the at least one script template.

The at least one template 22 has at least an input expression 54 in FIG. 2 or an output expression 56 in FIG. 2, wherein each input expression 54 and each output expression 56 are formatted using an associated plurality of syntax rules. The associated plurality of syntax rules operate to format complex, repeatable, and nested data structures. The plurality of syntax rules has at least one script directive, a plurality of operators, and a plurality of parameters.

The at least one script directive may be selected from the group of an optional directive ([ ]), a record index item directive (_#), a BEGIN directive, an END directive, a SHOW directive, a REPEAT BEGIN directive, a REPEAT END directive, a NESTED BEGIN directive, and a nested END directive, wherein each of the plurality of directives are described in more detail below.

Additionally, the plurality of operators may be selected from the group of a keyword substitution operator ($), a string concatenation operator (| |), and a delimiter operator. Additionally, the associated plurality of syntax rules further has a plurality of parameters selected from the group of a variable parameter, a qualifier parameter, and an alias name parameter.

As shown in a syntax diagram of the at least one script template 22 in FIG. 2, the at least one script template 22 has at least one of an input expression 54 (shown in more detail in FIG. 3), and an output expression 56 (shown in more detail in FIG. 6), wherein the input expression 54 operates to define requested input data sent from the destination system to the origination system in accordance with the associated plurality of syntax rules, and wherein the output expression 56 operates to transmit output data from the origination system to the destination system in accordance with the associated plurality of syntax rules.

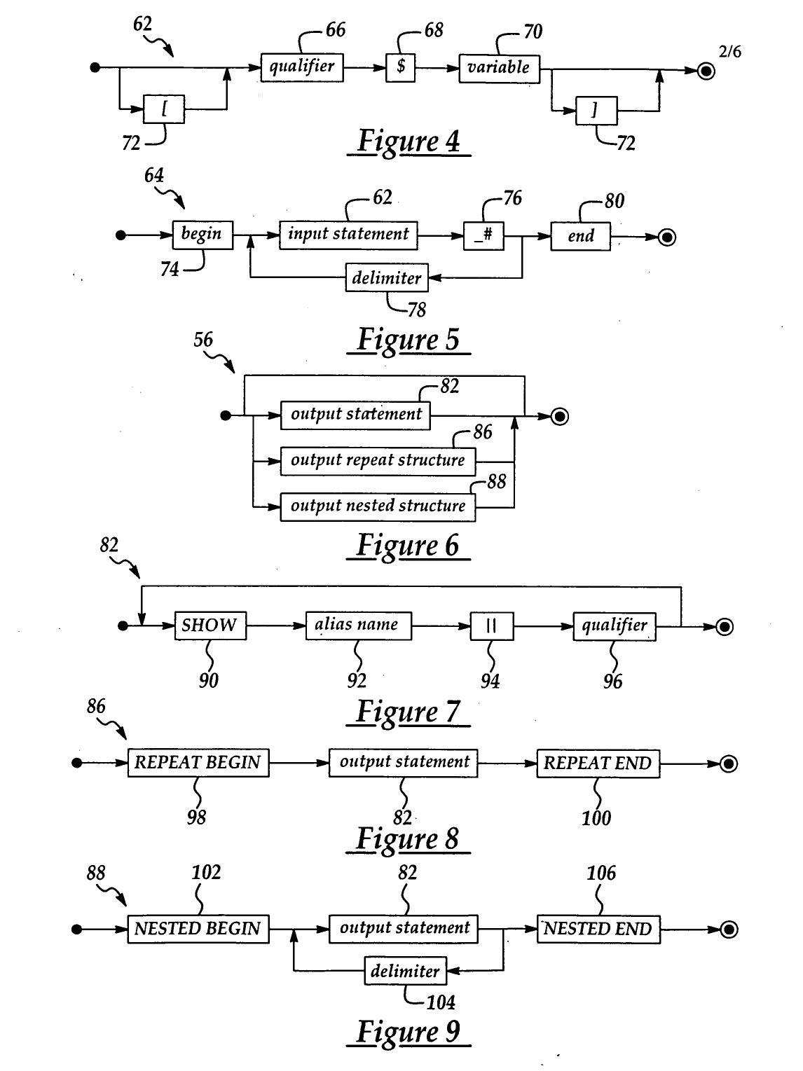

As shown in FIGS. 4-5 illustrating a syntax diagram of an input statement and an input structure, the input expression 54 preferably has at least one of an input statement 62 and an input structure 64. As shown in FIG. 4, the at least one input statement 62 has:

a qualifier parameter 66 specifying a content and a format of output data sent from a destination system to an origination system;

a keyword substitution operator 68 immediately following the qualifier parameter 66; and

a user-defined variable parameter 70 immediately following the keyword substitution operator 68, the user-defined variable parameter 70 defined within the destination system,

wherein the at least one input statement 62 defines at least one input sent from the destination system to the origination system in response to an origination system initiate input data request, and wherein the keyword substitution operator 68 substitutes the qualifier parameter 66 with the user-defined variable parameter 70 from the destination system.

The input expression 54 may further have an optional directive 72 enclosing an input statement 62 to define the input statement 62 disposed within the optional directive 72 as an optional input statement.

As shown in another preferred embodiment in FIG. 3, 5, and 10, the input expression 54 may further have an input structure 64. The input structure 64 having:

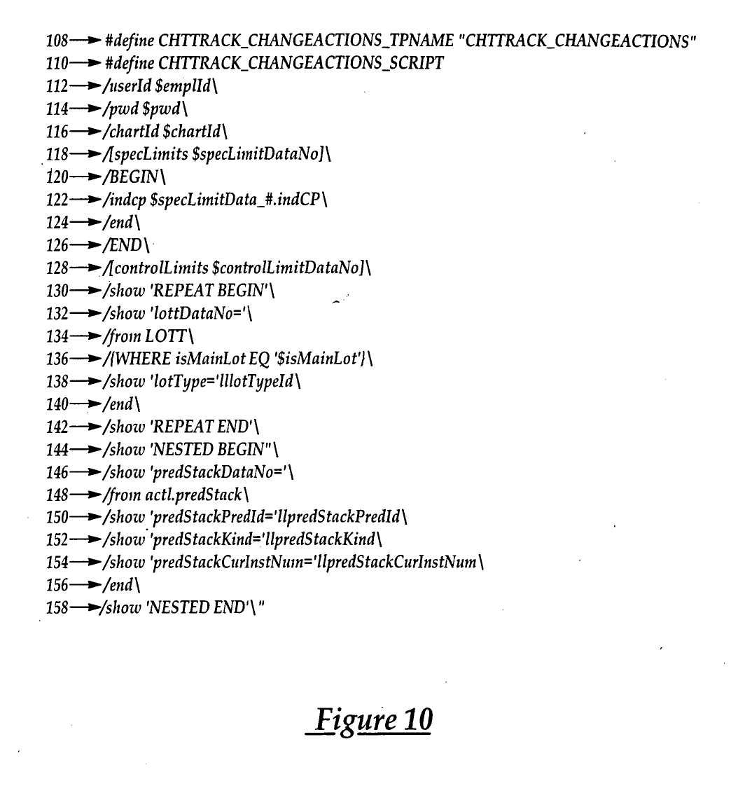

an indexed input item list (as shown in lines 120 through 126 in FIG. 10);

a plurality of input statements 62 disposed within the indexed input item list (as shown in lines 120 through 126 in FIG. 10);

a BEGIN directive 74 to define a beginning of the indexed input item list (as shown in lines 120 through 126 in FIG. 10);

a record index number directive 76 associated with each input statement 62 disposed within the index item list (as shown in lines 120 through 126 in FIG. 10);

a delimiter operator 78 to separate each input statement 62 within the indexed input item list (as shown in lines 120 through 126 in FIG. 10); and

an END directive 80 to define an end of the indexed input item list (as shown in lines 120 through 126 in FIG. 10).

As shown in another preferred embodiment in FIG. 6, the output expression 56 has at least one of at least one output statement 82, and an output structure, wherein the at least one output structure is selected from at least one of an output repeat structure 86, and an output nested structure 88.

The at least one output statement 82 having:

a show directive 90 for transmitting output data from the origination system to the destination system in accordance with syntax rules as defined in the at least one template 22, wherein the output data is translated via the generic script translation engine 24;

an alias name parameter 92 representing a name for output data sent from the system to the destination system;

a string concatenation operator 94; and

a qualifier parameter 96 for specifying a content and a format of output data sent from the origination system to the destination-system.

As shown in another preferred embodiment in FIG. 6, 8, and 9, the output expression 56 may further have an output structure selected from the group of an output repeat structure 86 and an output nested structure 88.

The output repeat structure 86 provides:

a REPEAT BEGIN directive 98 for defining a beginning of repetitive output data disposed within an indexed output from an origination system item list;

at least one output statement 82; and

a REPEAT END directive 100 for defining an ending of repetitive output data sent from the origination system to the destination system disposed within an indexed output item list.

The output nested structure 88 provides:

a NESTED BEGIN directive 102 defining a beginning of a nested indexed output item list, wherein each output item within the nested indexed output item list from the origination system has associated repetitive output data;

at least one output statement 82;

a delimiter operator 104 to separate each output statement 82; and

a NESTED END directive 106 defining an end to the nested indexed output item list, wherein the output data sent from the origination system to the destination system is formatted in accordance with the nested format of the at least one script template 22.

In one preferred embodiment, the PROMIS 16 is an origination system when the PROMIS sends an initiate data transfer request to the CIM 18 using a predefined script template (script template 1) disposed within the script template repository 20. Thus, the PROMIS 16 is the origination system having an associated script B1 associated with the script template 1, and the CIM is the destination system having an associated CIM script A1 also associated with the script template 1. Alternatively, the CIM system may be the an origination system and the PROMIS system may be the destination system, when the CIM system having an associated script A2 associated with script template 2 sends an initiate data transfer request to the PROMIS having an associated PROMIS script B2 also associated with script template 2.

The script translation engine 24 is context independent and operates to transfer data between the origination and destination systems using the at least one script template and origination data provided from the origination system using the origination system script and destination data provided from the destination system using the destination system script.

In operation, the destination system script sends input data to the engine for translation using the template upon receiving an origination script identifying an associated script template disposed within the script template repository.

The origination script then receives the translated input data from the engine destination system, wherein the translated input data is input into a memory location disposed within the origination system via an input expression as defined within the template.

Next, the origination script operates to send output data output from the origination system to the engine. The engine translates the output data using the template for use in the destination system. The destination system receives the translated output data via an output expression as defined within the template, wherein the translated output data is input into a memory location disposed within the destination system.

A preferred embodiment of a generic script template created using the fixed format terminology syntax rules of the present invention is shown in FIG. 10.

The first line 108 of the template defines a name of the template, wherein the template is labeled “CHTTRACK_CHANGEACTIONS” and is defined as a global variable for later processing.

The line 110 of the template defines the script as “CHTTRACK_CHANGEACTIONS_SCRIPT”.

The lines 112-128 define an input structure disposed within the template, wherein lines 112-118 define input statements, and wherein input qualifier parameters for the associated variable parameters sent from the destination system to the origination system, a user ID, a pwd, a chartID and a specLimits which function as qualifier parameters for their associated user-defined variable parameters, an empl ID, a pwd, a chartID, and a specLimitDataNo. Immediately following the qualifier parameters is the keyword substitution operator “$”. Additionally, immediately following the keyword substitution operator are the associated user-defined variable parameters.

Lines 120-126 define an input structure, wherein line 120 has a BEGIN directive defining a beginning of an input structure.

Line 122 first defines the input qualifier parameter “indcp” for the associated structure variable parameter “specLimitData” and then points the _# record index item directive at the record index “.indCP”.

Line 124 defines an “end” directive to define an end of the record indexes. In this example, only one record index is illustrated, however, in an alternate embodiment (not shown), additional record indexes may be used and may be separated by a delimiter.

The line 126 has an END directive defining that an input structure ends.

Line 128 has an optional input statement, wherein the input statement has an optional directive enclosing the input statement. The input statement having a qualifier parameter “controlLimits”, a keyword substitution operator “$” and a user-defined variable parameter “controlLimitDataNo”.

The lines 130-158 define an output structure of the template, wherein lines 130-142 define an output repeat structure, and lines 144-158 define an output nested structure.

Line 130 has a show directive followed by the REPEAT BEGIN directive.

Line 132 defines an output statement, defining a show directive followed by the alias name parameter ‘lottDataNo=’.

Line 134 defines a memory location “LOTT” disposed within the destination system for sending the repeat structure using a “from” command.

Line 136 uses the “WHERE” command to instruct the ENGINE to continue repeating the output repeat structure as long as the expression “isMaintLot EQ ‘$isMainLot’ is true”.

Line 138 defines an output statement, defining a show directive followed by the alias name parameter ‘lotTypeId=’, a string concatenation operator “| |” and a qualifier parameter “lotTypeId”.

Line 140 defines an “end” of the “WHERE” repeat loop.

Line 142 has a show directive followed by the REPEAT END directive.

Line 144 has a show directive followed by the NEST BEGIN directive.

Line 146 defines an output statement, defining a show directive followed by the alias name parameter ‘prcdStackDataNo=’.

Line 148 defines a memory location “actl.prcdStack” disposed within the destination system for the nested structure. Also shown in line 148 is a “from” command used to identify the beginning of a nested loop.

Line 150 defines an output statement, wherein a show directive defines an alias name parameter ‘prcdStackPrcdId=’, a string concatenation operator “| |” and a qualifier parameter “prcdStackPrcdId”.

Line 152 defines an output statement, wherein a show directive defines an alias name parameter ‘prcdStackKind=’, a string concatenation operator “| |” and a qualifier parameter “prcdStackKind”.

Line 154 defines an output statement, wherein a show directive defines an alias name parameter ‘prcdStackCurInstNum=’, a string concatenation operator “| |” and a qualifier parameter “prcdStackCurInstNum”.

Line 156 defines an “end” of the nested loop.

Line 158 provides a show directive, the show directive defining the NESTED END directive.

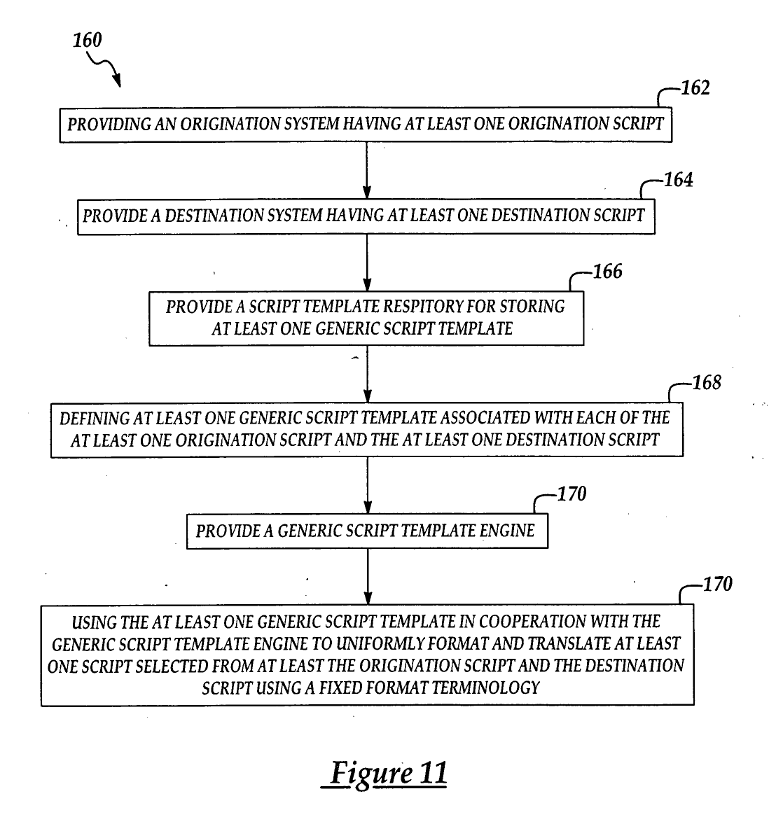

In accordance with a preferred embodiment of the present invention, FIG. 11 shows a method 160 of using a generic script template engine repository adapter system is provided herewithin. The method 160 having the steps of:

providing an origination system having at least one origination script (step 162);

providing a destination system having at least one destination script (step 164);

providing a script template repository for storing at least one generic script template (step 166);

defining at least one generic script template associated with each of the at least one origination script and the at least one destination script (step 168), wherein the at least one generic script template is disposed within the script template repository;

providing a generic script template engine (step 170);

using the at least one generic script template in cooperation with the generic script template engine to uniformly format and translate at least one script selected from at least the origination script and the destination script using a fixed format terminology (step 172), the fixed format terminology having a plurality of syntax items each arranged in accordance with an associated plurality of syntax rules used to define the at least one script template.

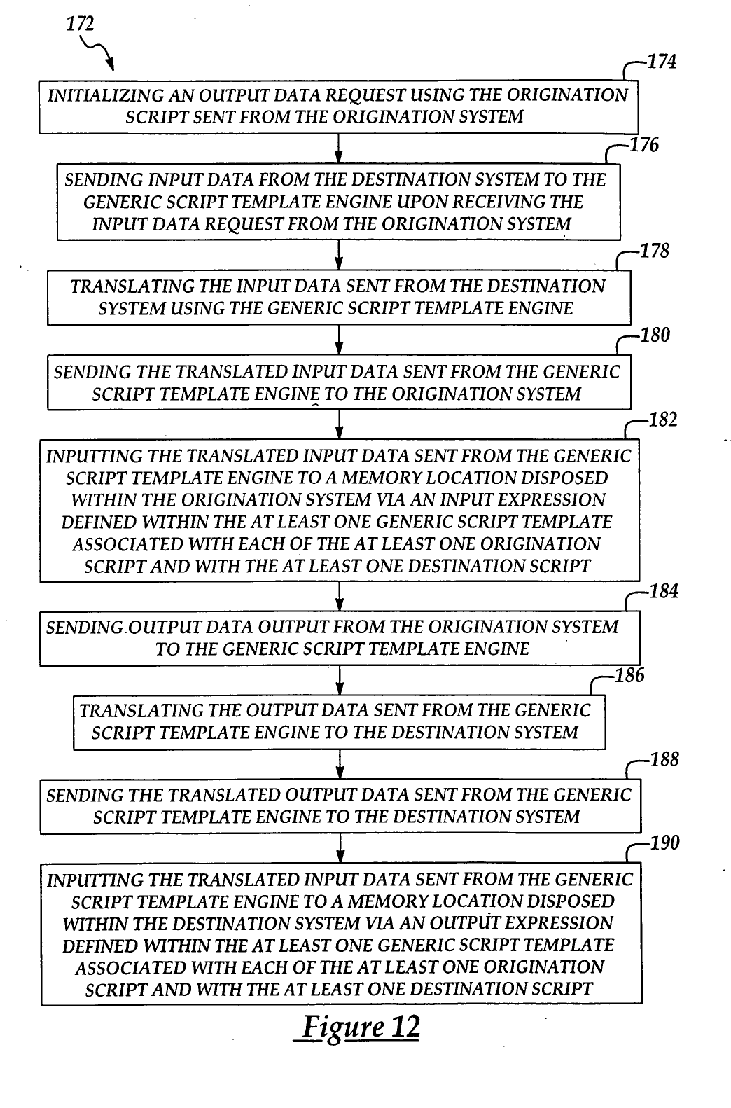

As shown in FIG. 12, the step of using the at least one generic script template in cooperation with the generic script template engine to uniformly format and translate at least one script selected from at least the origination script and the destination script using a fixed format terminology (step 172), preferably has the additional steps of:

a) initiating an input data request using the origination script sent from the origination system (step 174);

b) sending input data from the destination system to the generic script template engine upon receiving the input data request from the origination system (step 176);

c) translating the input data sent from the destination system using the generic script template engine (step 178);

d) sending the translated input data sent from the generic script template engine to the origination system (step 180);

e) inputting the translated input data sent from the generic script template engine to a memory location disposed within the origination system via an input expression defined within the at least one generic script template associated with each of the at least one origination script and with the at least one destination script (step 182);

f) sending output data output from the origination system to the generic script template engine upon completing step 182 (step 184);

g) translating the output data sent from the destination system using the generic script template engine (step 186);

h) sending the translated output data sent from the generic script template engine to the destination system (step 188); and

i) inputting the translated output data sent from the generic script template engine to a memory location disposed within the destination system via an output expression defined within the at least one generic script template associated with each of the at least one origination script and with the at least one destination script (step 190).

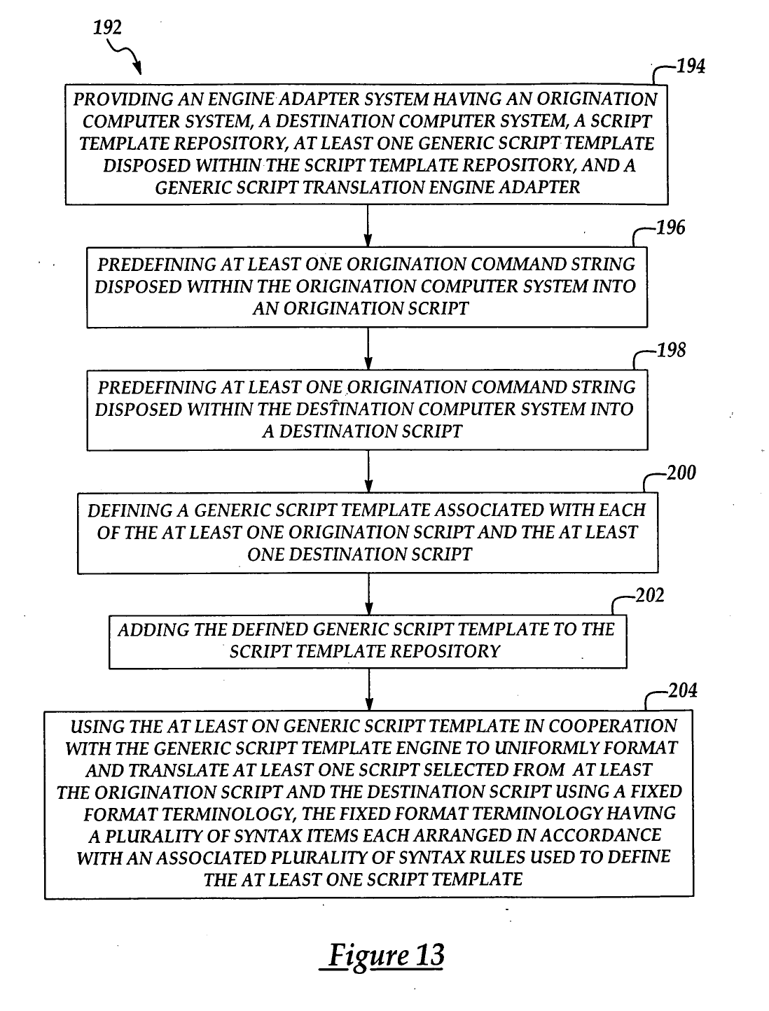

In accordance with another preferred embodiment of the present invention, as shown in FIG. 13 a method 192 of using a script translation adapter system is provided.

The method 192 has the steps of:

providing an engine adapter system having an origination computer system, a destination computer system, a script template repository, at least one generic script template disposed within the script template repository, and a generic script translation engine adapter (step 194);

predefining at least one origination command string disposed within the origination computer system into an origination script (step 196);

predefining at least one destination command string disposed within the destination computer system into a destination script (step 198);

defining a generic script template associated with each of the at least one origination script and the at least one destination script (step 200); and

adding the defined generic script template to the script template repository (step 202);

using the at least one generic script template in cooperation with the generic script template engine to uniformly format and translate at least one script selected from at least the origination script and the destination script using a fixed format terminology, the fixed format terminology having a plurality of syntax items each arranged in accordance with an associated plurality of syntax rules used to define the at least one script template (step 204).

From the foregoing, it should be appreciated that a generic script template engine repository system and method of use is provided.

While a preferred exemplary embodiment has been presented in the foregoing detailed description, it should be understood that a vast number of variations exist and this preferred exemplary embodiment is merely an example, and it is not intended to limit the scope, applicability or configuration of the invention in any way. Rather, the foregoing detailed description provides those of ordinary skill in the art with a convenient guide for implementing a preferred embodiment of the invention and various changes can be made in the function and arrangements of the exemplary embodiment without departing from the spirit and scope of the appended claims.

What is claimed is:

1. The generic script template engine repository adapter system comprising:
a first computer system;
a second computer system in operative communication with the first computer system;
a script template repository having at least one generic script template for formatting scripts transferred between the first computer system and the second computer system; and
a generic script translation engine adapter,
wherein the at least one generic script template cooperates with the generic script translation engine adapter to achieve fast script translation between the first computer system and the second computer system.

2. The adapter system of claim 1, wherein the first computer system is a process manufacturing integration system (PROMIS) having at least one transfer protocol server for generating at least one or a plurality of PROMIS scripts.

3. The adapter system of claim 2, wherein the PROMIS may be selected from at least one of an origination system, and a destination system, wherein the origination system has an origination script for sending an initial data request to the destination system, and wherein the destination system has a destination script for sending requested input data to the origination system.

4. The adapter system of claim 1, wherein the second computer system is a computer integrated manufacturing (CIM) system has a client application program having at least one client template server for generating a plurality of CIM client application program scripts.

5. The adapter system of claim 4, wherein the CIM may be selected from at least one of an origination system, and a destination system, wherein the origination system has an origination script for sending an initial data request to the destination system, and wherein the destination system has a destination script for sending requested input data to the origination system.

6. The adapter system of claim 1, wherein the script template repository comprises a plurality of script templates.

7. The adapter system of claim 1, wherein the at least one script template operates to uniformly format at least one script selected from at least an origination script and a destination script using a fixed format terminology, the fixed format terminology having a plurality of syntax items each arranged in accordance with an associated plurality of syntax rules used to define the at least one script template.

8. The adapter system of claim 7, wherein the at least one template comprises:
an input expression;
an output expression;
an associated plurality of syntax rules to format both the input expression and the output expression, respectively, wherein the input expression operates to define requested input data sent from a destination system using the destination script to an origination system having the origination script in accordance with the associated plurality of syntax rules, and wherein the output expression operates to transmit output data from the origination system to the destination system in accordance with the associated plurality of syntax rules.

9. The adapter system of claim 8, wherein the input expression comprises an input statement having
a qualifier parameter specifying a content and a format of output data sent from a destination system to an origination system;
a keyword substitution operator immediately following the qualifier; and
a user-defined variable parameter immediately following the qualifier parameter, the user-defined variable parameter defined within the destination system,
wherein the at least one input statement defines at least one input sent from the destination system to the origination system in response to an origination system initiate input data request, and wherein the keyword substitution substitutes the qualifier parameter with the user-defined variable parameter from the destination system.

10. The adapter system of claim 9, wherein the input expression further comprises:
an optional directive enclosing an input statement to define the input statement disposed within the optional directive as an optional input statement.

11. The adapter system of claim 8, wherein the input expression comprises an input structure having
an indexed input item list;
a plurality of input statements disposed within the indexed input item list;
a BEGIN directive to define a beginning of the indexed input item list;
a record index number directive associated with each input statement disposed within the index item list;
a delimiter operator to separate each input statement within the indexed input item list; and
an END directive to define an end of the indexed input item list.

12. The adapter system of claim 8, wherein the output expression comprises an output statement having
a show directive for transmitting output data from the origination system to the destination-system in accordance with syntax rules as defined in the at least one template, wherein the output data is translated via the generic script translation engine;
an alias name parameter representing a name for output data sent from the system to the destination-system;
a string concatenation operator; and
a qualifier parameter for specifying a content and a format of output data sent from the origination system to the destination-system.

13. The adapter system of claim 8, wherein the output expression comprises an output structure, wherein the output structure is selected from at least one of an output repeat structure, and an output nested structure.

14. The adapter system of claim 13, wherein the output repeat structure comprises:
a REPEAT BEGIN directive for defining a beginning of repetitive output data disposed within an indexed output from an origination system item list;
at least one output statement ; and
a REPEAT END directive for defining an ending of repetitive output data sent from the origination system to the destination system disposed within an indexed output item list.

15. The adapter system of claim 14, wherein the output nested structure comprises: a NESTED BEGIN directive defining a beginning of a nested indexed output item list, wherein each output item within the nested indexed output item list from the origination system has associated repetitive output data;
at least one output statement; and
a NESTED END directive defining an end to the nested indexed output item list, wherein the output data sent from the origination system to the destination-system is formatted in accordance with the nested format of the at least one script template.

16. The adapter system of claim 7, wherein the script translation engine is context independent and operates to transfer data between an origination system and a destination system using the at least one script template and origination data provided from the origination system using the origination script and destination data provided from the destination system using the destination script.

17. A method of using a generic script template engine repository adapter system comprising the steps of:
providing an origination system having at least origination script;
providing a destination system having at least one destination script;
providing a script template repository for storing at least one generic script template;
defining at least one generic script template associated with each of the at least one origination script and the at least one destination script, wherein the at least one generic script template is disposed within the script template repository;
providing a generic script template engine; and
using the at least one generic script template in cooperation with the generic script template engine to uniformly format and translate at least one script selected from at least the origination script and the destination script using a fixed format terminology, the fixed format terminology having a plurality of syntax items each arranged in accordance with an associated plurality of syntax rules used to define the at least one script template.

18. The method of claim 17, wherein the step of using the at least one generic script template in cooperation with the generic script template engine to uniformly format and translate at least one script selected from at least the origination script and the destination script using a fixed format terminology further comprises the steps of:
a) initiating an input data request using the origination script sent from the origination system;
b) sending input data from the destination system to the generic script template engine upon receiving the input data request from the origination system;
c) translating the input data sent from the destination system using the generic script template engine;
d) sending the translated input data sent from the generic script template engine to the origination system;
e) inputting the translated input data sent from the generic script template engine to a memory location disposed within the origination system via an input expression defined within the at least one generic script template associated with each of the at least one origination script and with the at least one destination script;
f) sending output data output from the origination system to the generic script template engine upon completing step 18f);
g) translating the output data sent from the destination system using the generic script template engine;
h) sending the translated output data sent from the generic script template engine to the destination system; and
i) inputting the translated output data sent from the generic script template engine to a memory location disposed within the destination system via an output expression defined within the at least one generic script template associated-with each of the at least one origination script and with the at least one destination script.

19. A method of using a script translation adapter system, comprising the steps of:
providing an engine adapter system having an origination computer system, a destination computer system, a script template repository, at least one generic script template disposed within the script template repository, and a generic script translation engine adapter;
predefining at least one origination command string disposed within the origination computer system into an origination script;
predefining at least one destination command string disposed within the destination computer system into a destination script;
defining a generic script template associated with each of the at least one origination script and the at least one destination script; and
adding the defined generic script template to the script template repository;
using the at least one generic script template in cooperation with the generic script template engine to uniformly format and translate at least one script selected from at least the origination script and the destination script using a fixed format terminology, the fixed format terminology having a plurality of syntax items each arranged in accordance with an associated plurality of syntax rules used to define the at least one script template.
